(19) United States
(12) Patent Application Publication
(10) Pub. No.: US 2026/0321770 A1
(43) Pub. Date: Oct. 15, 2026

(54) Thermal Energy System for Controlling a Temperature of a Battery Section Having a Battery of a Vehicle, and Vehicle

(71) Applicant: ZF Friedrichshafen AG, Friedrichshafen (DE)

(72) Inventors: Axel Rohm, Schonungen (DE); Nico Scholl, Kressbronn (DE); Tobias Höche, Hallstadt (DE); Detlef Gierling, Röthlein (DE)

(21) Appl. No.: 19/482,949

(22) PCT Filed: Apr. 15, 2024
(86) PCT No.: PCT/EP2024/060108

§ 371 Date: Nov. 10, 2025

(30) Foreign Application Priority Data
May 10, 2023 (DE) 102023204339.4

(51) Int. Cl. H01M 10/625; H01M 10/613; H01M 10/615; H01M 10/6568; H01M 10/6569; H01M 10/663; H01M 10/667

(52) U.S. Cl. CPC H01M 10/625; H01M 10/613; H01M 10/615; H01M 10/6568; H01M 10/6569; H01M 10/663; H01M 10/667

(57) ABSTRACT

A thermal energy system for controlling a temperature of a battery section having a battery of a vehicle includes a heat pump with a cooling unit and a heating unit. A low-temperature coolant line path begins downstream of the cooling unit, and a high-temperature coolant line path begins downstream of the heating unit. The system further includes a battery access line fluidically connected to a coolant inlet of the battery section, and a battery bypass for conducting the coolant of one of the line paths at least partially parallel to the battery section. Additionally, the system includes a first valve, with the first valve fluidically connecting the one of the line paths to the battery access line when in a first switching state, and with the first valve fluidically connecting the one of the line paths to the battery bypass when in a second switching state.

### CROSS-REFERENCE TO RELATED APPLICATIONS

The present application is related and has right of priority to German Patent Application No. 10 2023 204 339.4 filed on May 10, 2023 and is a nationalization of PCT/EP2024/060108 filed in the European Patent Office on Apr. 15, 2024, both of which are incorporated by reference in their entirety for all purposes.

### FIELD OF THE INVENTION

The invention relates generally to a thermal energy system for controlling a temperature of a battery section having a battery of a vehicle and to a vehicle having such a thermal energy system.

### BACKGROUND

Electric vehicles require a cooling system to dissipate the power losses that arise in assemblies (e.g., battery, electric machine; reduction gear unit; bearings, etc.) and electronics units (e.g., inverter, DC/DC converter, DC/AC converter, etc.) during operation and during the charging of the battery.

The vehicles usually have multiple cooling circuits, which are partly coupled to one another in order to form a thermal management system. In general, a coolant circuit having a water-glycol coolant is present, via which the heat is dissipated to the surroundings. A further coolant circuit includes a heat pump/AC compressor for air conditioning the passenger compartment or for assisting in the dissipation of heat from the components of the vehicle. A third coolant circuit is provided in many systems for dissipating heat from the lube oil-and cooling oil-system of the transmission.

In the known systems, two fundamental principles regarding the interior air conditioning and the cooling of the electronics units prevail. The passenger compartment is heated by a coolant heat exchanger from the cooling circuit of the electrical propulsion unit and is cooled via the refrigeration circuit of the air conditioning system/heat pump, which requires additional heat exchangers for the air conditioning system. For greater heat output, additional electrical heaters are usually necessary, which directly heat either the coolant flow or the interior air of the passenger compartment.

The second principle bundles the functions of heating and cooling via the refrigeration circuit in that, rather than a heating heat exchanger, a condenser heat exchanger is used and the air is either heated or cooled by the same, according to demand.

A common feature of all systems is that the electronics units with respect to cooling are connected in series upstream of the electric machine, wherein the coolant preheated by the electronics units is still sufficient for cooling the electric machine.

The energy store/rechargeable battery/battery also has losses during energy conversion due to the chemical and physical processes within the battery. The effect depends on power, such that, at low powers, the power loss is also low and the greater the energy conversion is, the higher are the internal losses. Thus, liquid cooling is found in most systems. Cooling and heating the individual components of the vehicle in a targeted manner is therefore difficult to implement and often requires complicated thermal management systems. This also results in limitations of the performance of the propulsion unit or of other requirements, for example the air conditioning of the passenger compartment.

DE 10 2020 122 306 A1 describes a heat pump system for a vehicle, in which a cooling and heating of different elements, such as a battery of the vehicle, are described.

### SUMMARY OF THE INVENTION

One problem addressed by the present invention is that of providing a thermal energy system and a vehicle, which at least improve one or more of the aforementioned disadvantages. In particular, one problem addressed by the present invention is that of providing a thermal energy system for a vehicle, in which a specified temperature of the battery is achievable while taking account of target temperatures of the further components of the vehicle.

The problem is solved according to a first aspect by a thermal energy system or a thermal management system for controlling a temperature of a battery section having a battery of a vehicle. The system includes a heat pump with a cooling unit for cooling a coolant, and with a heating unit for heating the coolant, a low-temperature (LT) line path beginning downstream of the cooling unit for conducting the coolant, and a high-temperature (HT) line path beginning downstream of the heating unit for conducting the coolant. The system also includes a battery access line, which is fluidically connected to a coolant inlet of the battery section, and at least one first valve. When the first valve is in a first switching state, one of the HT or LT line paths, in particular the LT line path, is fluidically connected to the battery access line and, when the first valve is in a second switching state, the one of the HT or LT line paths is fluidically connected to a battery bypass. The system also includes the battery bypass, which conducts the coolant of the one of the HT or LT line paths, in particular the LT line path, at least partially parallel to the battery section.

The invention relates to the thermal energy system, which may always transport the lost energies from the electrical components and the energy from the cooling of the passenger compartment, as described in particular in the following, to where this is useful or may be stored in the thermal mass for later use. Once the demands and the storage capacities have been filled, the energy may be discharged to the surroundings, in particular to the ambient air.

In order to increase the efficiency, a heat pump is provided, which transmits energy from the coolant with a lower temperature level to the coolant with a higher temperature level, in order to thus provide, in particular, the coolant for the LT and HT line paths. The coolant of the LT line path may have a lower temperature level in comparison to the coolant of the HT line path, at least in some sections. Due to different flows, it may be made possible by the heat pump to also use energy from the ambient air for heating purposes. In addition, the heat pump may make it possible to cool/air-condition the passenger compartment.

The basic idea of the system according to the invention is based on the implementation of two coolant circuits consisting of a low-temperature circuit with the LT line path and a high-temperature circuit with the HT line path having a different temperature level. The relationship of the temperatures of the circuits may be −10 K to +100 K between a temperature of the HT circuit minus a temperature of the LOT circuit. The thermal coupling of the two coolant circuits is established via the heat pump. This may include at least one compressor, at least one expansion valve, at least one evaporator heat exchanger (coolant-refrigerant heat exchanger) on the LT circuit for absorbing energy from the cooling circuit, and a liquid cooled condenser (LCC) on the HT circuit, and an expansion tank or collector and/or dryer.

At least first through third valves (flow switches) may be arranged in such a way that, due to the particular combination of the switching states of the valves, all necessary operating states may be served using the system. At least one of the first through third valves may be provided as a radial rotary slide valve, although another design, such as an axial piston valve, is also possible.

The system may have a main circuit or a main coolant circuit of the coolant. The main circuit may, in particular, cool and/or heat at least one of the following sections: a cooling section, a motor section, a heating section, and a radiator section. In addition, the main circuit may heat and/or cool the battery section.

One of the first through third valves, in particular the first valve, may be integrated into the hydraulic main circuit in such a way that, in a first switching state, the coolant flows to the battery section, in particular to the battery, whereas in a second switching state, the coolant is conducted past the battery, in particular via the battery bypass, such that an exchange of energy preferably does not take place between the battery and the coolant flowing in the main circuit. The battery may thus be decoupled from the main circuit of the thermal system. As a result, the thermal mass of the battery B may be selectively included in or excluded from the active heat balance, for example, for the purpose of heating the passenger compartment more quickly or of reaching the target temperature of the heating circuit and/or of the cooling circuit of the main circuit more quickly. Due to the very high thermal capacity of a traction battery, including the water fill level, the heating time to reach the target temperature in the heating circuit may be reduced by approximately 50% to 80%, given the same heat output.

The system may be designed in such a way that, during an intermittent operation such that there is a switch between the first and the second switching states of the first valve, the temperature level of the battery may be adjusted in a specified range and/or a switching hysteresis. A time interval and/or a time ratio between the two switching states may determine an amount of the coolant through the battery, and thus the cooling power and the amplitude of the hysteresis of the battery temperature level.

The time interval may be between 0%-100%. It may be advantageous to shut down the flow through the battery section, in particular of the battery, only for a relatively short duration and to add a certain average minimum volumetric flow, for example, in order to homogenize the battery temperature and to avoid hot spots in the battery. The period of time may be determinable as a function of the coolant temperature in the battery section, in particular at the battery, and should, in particular, not be higher than a boiling temperature of the coolant. The coolant temperature in the battery section, in particular at the battery, may be selected with respect to the boiling temperature in such a way that effects on a coolant flow of the coolant at and/or in the battery, in particular a volumetric flow, pressure loss, etc., are taken into account, advantageously under the condition that the least favorable position in the battery is used as the reference variable. The least favorable position may be a point on or in the battery that has a highest temperature.

Accordingly, the cooling of the battery may be oriented on same. The flow of the coolant in the battery and/or past cells of the battery may be decisive for the cooling of the battery, since the same flow conditions cannot prevail at every point of the battery.

There are regions and/or positions within the battery that are warmer or colder and these may be taken into account as parameters for the cooling control.

It may be advantageous to vary the volumetric flow of the main circuit between a switched-on and switched-off battery, in particular by the first and the second switching states of the first valve. Due to a high volumetric flow, a high amount of energy may be supplied to/withdrawn from the battery in a short time and an optimal exchange of coolant may be achieved at the same time. In contrast, a low volumetric flow may assist in the heating of the battery due to self-heating, in that this avoids local temperature spikes, but only very low amounts of energy are dissipated into the main circuit. During active battery heating by the main circuit, it may be useful to vary the volumetric flow in order to advantageously lower the exit temperature of the coolant at the battery to the greatest extent possible and to store all energy in the battery, whereas, due to a high volumetric flow, a more homogeneous temperature distribution in the battery is achievable. The temperature control of the battery may be established in accordance with target settings or a specified temperature.

The coolant temperature at the battery, in particular cells of the battery, may be determined by direct measurement or preferably indirectly, advantageously via an empirical computational model. At a maximum specified coolant temperature, a correspondingly adapted safety margin with respect to the boiling limit of the coolant may be taken into account, which safety margin takes a model error into account.

The battery section may consist of the battery. Alternatively, the battery and further units and/or lines, in particular of the system, may be arranged in the battery section.

The system includes the first valve and may include at least one further valve. The system may include at least the second, the third, and/or a fourth valve.

At least one of the first through fourth valves may be a 4/2 valve or a 3/2 valve. The first through fourth valves may be at least partially identical valves and/or at least partially different valves. At least two of the first through fourth valves may be different and combined, in particular to form a 5/2 valve. Advantageously, the first valve may be a 3/2 valve and the second and the third valves may each be a 4/2 valve. Additionally or alternatively, the fourth valve may be a 3/2 valve. Alternatively, the first valve may be a 4/2 valve.

The system may also include a battery outlet line, which is fluidically connected to a coolant outlet of the battery section, in particular of the battery, wherein the battery outlet line and the battery bypass are merged downstream of the battery section to form one single line. The battery inlet line may be fluidically connected, in particular, to a coolant inlet of the battery. Therefore, the coolant flows of the battery bypass and of the battery outlet line may be merged to form one common coolant flow.

The battery access line and/or the battery outlet line may include and/or form the coolant inlet and the coolant outlet, respectively, of the battery section, in particular of the battery.

“Downstream of” and “upstream of” may relate to a flow direction of the coolant. If a line conducts the coolant from a first unit to a second unit, this may include the coolant flowing from the first unit to the second unit.

The battery bypass may have a first bypass line, which at least partially conducts the coolant from the battery bypass to the battery access line of the battery section, in particular of the battery. The first bypass line may be connected directly to the battery access line.

The first bypass line may cool and/or heat at least one first electronics unit of the vehicle. Therefore, the battery section, in particular the battery, may be connectable in series to the first electronics unit of the vehicle.

The first electronics unit and further electronics units mentioned in the following may be or include a power electronics system. The first electronics unit and the further electronics unit may be one of an inverter, a DC/DC converter, and/or a DC/AC converter.

The first bypass line may have an orifice and/or a restrictor, in particular upstream of the first electronics unit. Additionally, or alternatively, the battery bypass may have an orifice and/or a restrictor, in particular downstream of the first bypass line. By the restrictors and/or orifices, a branched-off volumetric flow may be limited in such a way that local temperature differences, in particular hot spots of the battery, may be avoided, but a substantial exchange of energy with the main circuit does not take place. By the restrictor(s) and/or the orifice(s), a branched-off volumetric flow may be limited. The orifice and/or the restrictor, or the orifices and/or the restrictors, may be changeable, such that the volumetric flow over the battery bypass may be adapted according to demand.

The system may also include a looped circuit, which at least partially conducts the coolant from the battery outlet line of the battery section, in particular of the battery, to the first valve, in particular when the first valve is in the second switching state, to the battery access line. The looped circuit may be and/or include a line.

The looped circuit may implement a convective and/or gravity-driven circulation of a coolant in the looped circuit and the battery. The looped circuit may include a restrictor and/or an orifice. Due to a heating of the coolant in the battery section, in particular the battery, the heated coolant may rise and, at the same time, pull cooler coolant along. The heated coolant may be conductable via the looped circuit back to the battery access line. Accordingly, a passive coolant flow may be produced.

In the first switching state of the first valve, the looped circuit may be disconnected from the battery access line. In this first switching state, the supply of the coolant of the one of the LT or HT line paths directly from the first valve to the battery access line, in particular the battery, is possible.

The looped circuit may include a coolant pump, in particular for pumping the coolant in the looped circuit.

Therefore, a coolant flow through the battery section may be decoupleable from the main circuit; however, in particular the coolant outlet of the battery is fluidically connected to the coolant inlet of the battery, such that a cooling of the battery is possible passively via the housing. Due to local temperature differences, a flow of the coolant and thus a homogenization of the temperature distribution in the battery may be possible. The battery is preferably appropriately selected in order to assist in the convection. The battery is advantageously arranged in such a way that differences in density between coolant having different temperature levels avoid a local overheating in that the warmer coolant rises and the colder coolant flows in thereafter.

The system may also include a Venturi nozzle and/or a suction jet pump, which is fluidically connectable or connected to the battery section, in particular the battery, by the battery outlet line and to the first valve by the battery bypass, in particular when the first valve is in the second switching state. The system may also include a cooling line, which at least partially conducts the coolant from the battery bypass to the first valve, in particular when the first valve to the battery access line is in the second switching state. The Venturi nozzle may at least partially suction the coolant from the battery outlet line. If the battery access line is connected to the cooling line, coolant in the cooling line is therefore sucked in. When the first valve is in the first switching state, the coolant may flow from the battery outlet line to the Venturi nozzle and, via the same, further to the main circuit and/or the single line.

Alternatively to the Venturi nozzle, the system may be designed in such a way that a line end section of the battery bypass has a first diameter and the line end section projects at least partially into the single line. The single line may have a second diameter at least along a line starting section, into which the line end section of the battery bypass at least partially projects. The first diameter may be smaller than the second diameter. If the coolant flows at a higher speed from the battery bypass into the single line, a suction is generated and thus a pressure drop is produced between the line end section and the line starting section. Sucking-in from a further connection is therefore possible, namely from the battery outline line here. A suction jet may therefore be produced.

The system may also include a heat exchanger or be designed to conduct the coolant to this heat exchanger, wherein the heat exchanger is arranged in the battery section. The thermal energy system may also have an independent battery circuit, which cools and/or heats the battery by a second coolant. The independent battery circuit may be, in particular, independent of the main circuit. A coolant inlet of the heat exchanger for the coolant may form the coolant inlet of the battery section and a coolant outlet of the heat exchanger for the coolant may form the coolant outlet of the battery section. The heat exchanger may exchange thermal energy between the independent battery circuit and a coolant flow from the battery access line to the battery outlet line. The second coolant may be identical to or different from the coolant. The second coolant may physically have a greater change in density with respect to temperature in comparison to the coolant and thus optimize the cooling effect. The independent battery circuit may include one or more lines for conducting the second coolant.

The first coolant may be a water-polyethylene glycol mixture for instance Glysantin®. The second coolant may be a coolant which is suitable and/or used for absorber refrigerators. The second coolant may include or consist of an ammonia-water mixture or alcohols. A boiling point of the first and/or the second coolant may be attuned to a specified temperature level of the units to be cooled and/or heated, in particular a permissible temperature level.

The system may also include an electronics bypass, which at least partially conducts the coolant from the battery bypass to the battery outlet line and to cool and/or heat a second electronics unit of the vehicle. The second electronics unit is arranged, in particular, upstream of the battery outlet line and, advantageously, along the electronics bypass.

The system may also include a second bypass line, which begins upstream of the second electronics unit and at least partially conducts the coolant from the electronics bypass to the battery access line, in particular directly thereto.

The electronics bypass and/or the second bypass line may include an orifice and/or a restrictor. The electronics bypass may have the orifice and/or the restrictor upstream of the electronics unit and downstream of the beginning of the second bypass line.

Advantageously, when the first valve is in the second switching state, the coolant may flow at least partially over the electronics bypass and the battery bypass in accordance with the valves and/or restrictors. When the first valve is in the first switching state, the coolant may flow from the one of the HT or LT line paths directly from the first valve via the battery access line to the battery section, in particular the battery. When the first valve is in the second switching state, the branched-off volumetric flows may be limited in such a way that hot spots on the battery may be avoided, but a substantial introduction of energy into the cooling circuit of the main circuit of the coolant of the system does not take place. By the electronics bypass, a parallel temperature control of the second electronics unit according to demand is possible.

The thermal energy system may cool and/or heat, by the HT and LT line paths,
a cooling section with at least one third electronics unit, in particular two, three or more third electronics units of the vehicle and/or a passenger compartment heat exchanger for cooling a passenger compartment of the vehicle,
a motor section having a motor of the vehicle, wherein the thermal energy system conducts the coolant flow from the motor section to the heating unit,
a heating section having a passenger compartment heat exchanger for heating the passenger compartment, and/or
a radiator section having a radiator of the vehicle.

The system may include one or more of the units of the aforementioned sections.

The system may include the second valve, which, when in a first switching state, fluidically connects the cooling section to the radiator section and the heating section to the first valve, wherein the second valve, when in a second switching state, fluidically connects the cooling section to the first valve and the heating section to the radiator section. Alternatively or additionally, the system may include the third valve, which, when in a first switching state, fluidically connects the single line to the motor section and the radiator section to the cooling unit, wherein the third valve, when in a second switching state, fluidically connects the single line to the cooling unit and the radiator section to the motor section.

One of the valves which connects a section, a line or unit to another section, another line, or another unit, may include connecting respective lines of same.

The thermal energy system may be designed in such a way that, when the radiator is in an open state, a thermal energy exchange is providable between an ambient fluid, in particular ambient air of the surroundings, and the coolant in the radiator section. The thermal energy system may be designed in such a way that, when the radiator is in a closed state, the thermal energy exchange with the ambient fluid is at least partially suppressible. The thermal energy system may also include a radiator device. Alternatively, the radiator section may include such a radiator device. The radiator device may make it possible either for the air to flow through the radiator device (open state) or prevent a through-flow (closed state).

When the first valve is in the first switching state, the second valve may be in the second switching state and/or the third valve may be in the first switching state, wherein, in particular, the radiator may be in the closed state, such that an energy exchange with the ambient air is suppressed.

When the first valve is in the second switching state, the second valve may be in the second switching state and/or the third valve may be in the first switching state. In particular when the radiator is in the open state, a reduced exchange of energy with the ambient air may be made possible, whereas, when the radiator is in the closed state, an exchange of energy with the ambient air is suppressed.

The system may also include a radiator bypass and include a fourth valve. The fourth valve may be designed in such a way that, when the fourth valve is in a first switching state, the coolant is conductable to the radiator bypass and, when the fourth valve is in a second switching state, to the radiator section. The radiator bypass may be designed in such a way that the coolant is conductable parallel to the radiator section. In particular when the first valve is in the second switching state, the fourth valve may be in the first switching state. As an effect thereof, the thermal capacities of the battery and of the coolant in the radiator circuit may be excluded, so that the response time of the system, for example to heat the passenger compartment, may be further reduced.

The fourth valve may be in the first switching state, the first valve may be in the second switching state, the second valve may be in the first switching state, and/or the third valve may be in the second switching state.

In addition, different combinations of the switching states of the first through fourth valves are possible in order to enable different operating modes for cooling and/or heating the one section and unit or the different sections and units.

The problem is solved according to a second aspect by a vehicle including a thermal energy system according to the first aspect. The vehicle may be an at least partially electrically propelled vehicle. The vehicle may include one or more units of the vehicle sections.

### BRIEF DESCRIPTION OF THE DRAWINGS

Preferred exemplary embodiments are explained by way of example on the basis of the accompanying figures. Wherein:

FIG. 1 shows a first exemplary embodiment of a thermal energy system having a battery bypass with a closed state of a radiator;

FIG. 2 shows the first exemplary embodiment of FIG. 1 with an open state of the radiator;

FIG. 3 shows second example aspects of a thermal energy system having a battery bypass and a radiator bypass;

FIG. 4 shows third example aspects of a thermal energy system having a battery bypass and a bypass line;

FIG. 5 shows fourth example aspects of a thermal energy system having a battery bypass and a bypass line;

FIG. 6 shows fifth example aspects of a thermal energy system having a battery bypass and a looped circuit;

FIG. 7 shows sixth example aspects of a thermal energy system having a battery bypass and a Venturi nozzle;

FIG. 8 shows seventh example aspects of a thermal energy system having a battery bypass and an independent battery circuit;

FIG. 9 shows eighth example aspects of a thermal energy system having a battery bypass and an electronics bypass;

FIG. 10 shows ninth example aspects of a thermal energy system having a battery bypass, an electronics bypass, and a bypass line; and

FIG. 11 shows a vehicle having a thermal energy system according to FIGS. 1 through 10.

In the figures, identical or substantially functionally identical or functionally similar elements are labeled with the same reference characters. Lines are represented in the form of arrows and/or dashes, wherein the arrow direction represents a flow direction of a coolant. The lines fluidically connect particular shown units and/or lines to one another.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

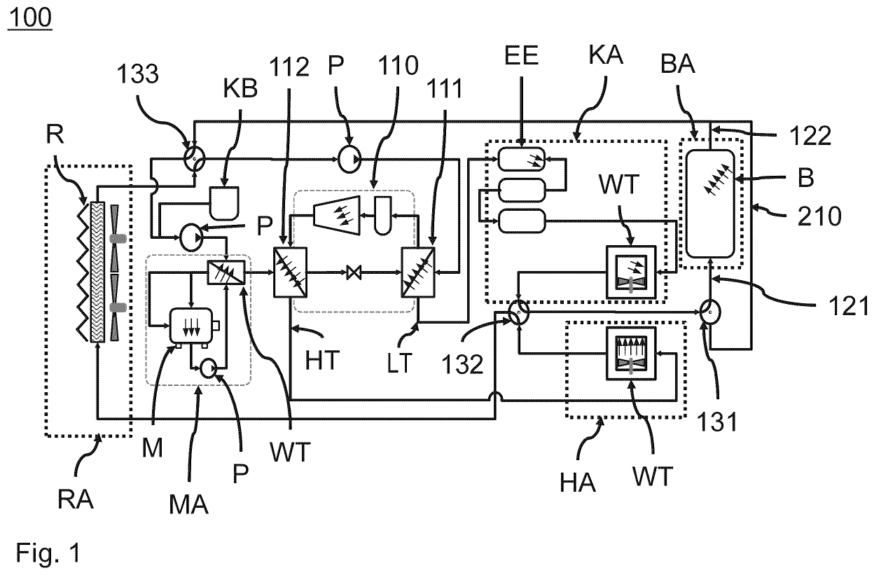

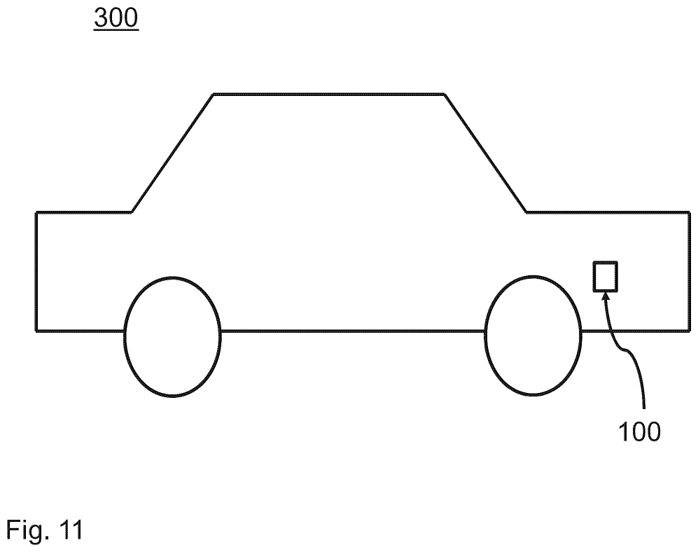

FIG. 1 shows a first exemplary embodiment of a thermal energy system 100 having a heat pump 110, wherein the thermal energy system 100 cools and/or heats a cold or cooling section KA having three electronics units EE and a passenger compartment heat exchanger WT for cooling a passenger compartment, a battery section BA having a battery B, a heating section HA having a passenger compartment heat exchanger WT for heating the passenger compartment, a radiator section RA having a radiator R, and a motor section MA having a motor M of the vehicle 300 (FIG. 11). The motor section MA also includes its own coolant circuit, which exchanges thermal energy with a coolant of a main circuit of the thermal energy system 100 by a heat exchanger WT of the motor section MA. The figures also show pumps P for pumping the coolant or the coolants of the lines and of the system 100 and a coolant container KB, which accommodates and releases the coolant of the main circuit.

The system 100 from FIG. 1 also has first, second, and third valves 131, 132, 133, each of which is switchable between a first and a second switching state and, in accordance with the switching states, fluidically connects the shown lines, units, and sections to one another. The heat pump 110 includes a cooling unit 111 for cooling the coolant and a heating unit 112 for heating the coolant. Downstream of the cooling unit 111, a low-temperature (LT) line path begins and, downstream of the heating unit 112, a high-temperature (HT) line path begins. The heat pump 110 also includes a compressor, an expansion valve, an evaporator heat exchanger in the form of the cooling unit 111 and an expansion tank, and a liquid cooled condenser in the form of the heating unit 112.

In order to be able to reach a specified temperature of the battery B as easily as possible while taking account of the target temperatures of the other components, such as the motor M and the heat exchanger WT of the passenger compartment, the coolant is conductible, by the first valve 131 in a first switching state, from the second valve 132, in particular from the cooling section KA and thus from the low-temperature (LT) line path, to the battery section BA having the battery B. For this purpose, the first valve 131 connects the line from the second valve 132 to a battery access line 121. The battery access line 121 is connected to a coolant inlet of the battery section BA, namely the battery B here, in order to cool the battery B by the coolant. A coolant outlet of the battery section BA, namely the battery B here, is connected to a battery outlet line 122. In this switching state, the coolant flows via the battery access line 121 and not via a battery bypass 210. The battery bypass 210 and the battery outlet line 122 are merged downstream of the battery B to form a single line, which conducts the coolant to the third valve 133.

The second valve 132 is in a second switching state in FIG. 1 and connects the cooling section KA to the first valve 131 and the heating section HA to the radiator section RA.

The third valve 133 is shown in a first switching state in FIG. 1 and connects the single line to the motor section MA and connects the radiator section RA to the cooling unit 111. The motor section MA is fluidically connected to the heating unit 112 downstream of the heat exchanger WT of the motor section MA.

In addition, the radiator R is shown in a closed state in FIG. 1, such that a thermal energy exchange between a coolant in the radiator section RA with ambient air is suppressed or takes place only to a very low extent.

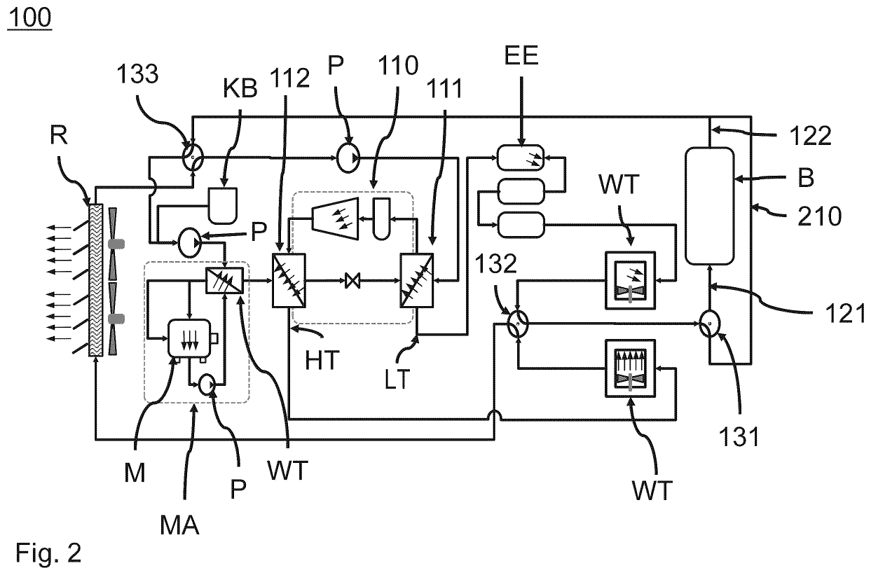

FIG. 2 shows, in comparison to FIG. 1, the first valve 131 in a second switching state, in which the coolant is conducted from the second valve 132 to the battery bypass 210.

The battery bypass 210 extends parallel to the battery section BA and a thermal energy exchange with the battery B does not take place. In addition, the radiator R is shown in an open state and a thermal energy exchange with the ambient air takes place. In FIG. 2 and in the following figures, the representation of the sections BA, KA, HA, RA, MA, which are indicated using dotted lines in FIG. 1, have been partly omitted in order to obtain a cleaner figure.

By the system 100 according to the invention, the thermal mass of the battery B is selectively included in or excluded from the active heat balance, for example, for the purpose of heating the passenger compartment more quickly or of reaching the target temperature of a heating circuit and/or of a cooling circuit of the main circuit more quickly. The heating circuit may be a coolant circuit that begins at the heating unit 112 and ends at same. The cooling circuit may be a coolant circuit that begins at the cooling unit 111 and ends at same. Due to the very high thermal capacity of a traction battery, including the water fill level, the heating time to reach the target temperature in the heating circuit is reduced by approximately 50% to 80%, given the same heat output.

During an operation switching between the first and the second switching states of the first valve 131, the temperature level of the battery B may be adjusted in a desired tolerance range or a switching hysteresis by intermittent operation. The time interval and the time ratio between the positions determines the cooling power or the amplitude of the switching hysteresis.

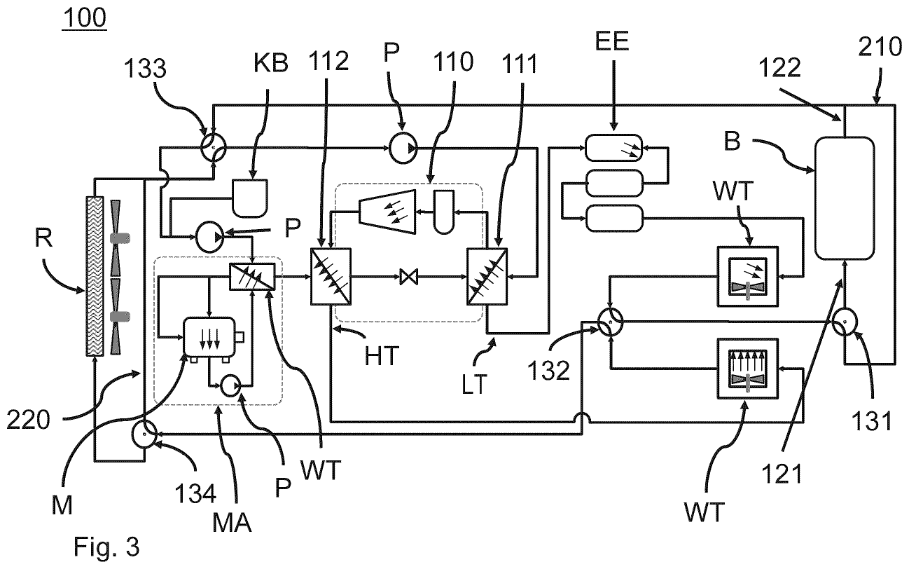

Each of the first, second, and third valves 131, 132, 133 and a valve 134 (FIG. 3) described in the following may have at least a first switching state and a second switching state. The second valve 132, when in a first switching state, may fluidically connect the cooling section KA to the radiator section RA. The third valve 133, when in a second switching state, may fluidically connect the single line to the cooling unit 111 and fluidically connect the radiator section RA to the motor section MA.

By the first and the second switching states of the first, second, and third valves 131, 132, 133, in particular of the first through fourth valves 131 through 134, the different sections shown may be cooled and/or heated according to demand.

FIG. 3 shows a second example aspect of a thermal energy system 100 which, in comparison to FIG. 2, also includes a radiator bypass 220 and the fourth valve 134.

The radiator bypass 220 conducts the coolant parallel to the radiator section RA, in particular to the radiator R and to the third valve 133. By the fourth valve 134, the coolant is conductible from the cooling section KA or the heating section HA (depending on the switching state of the second valve 132) to the radiator section RA, in particular to the radiator R, when the fourth valve 134 is in a first switching state, and to the radiator bypass 220 when the fourth valve 134 is in a second switching state (FIG. 3). By the radiator bypass 220 and the fourth valve 134, the thermal capacity in the radiator section RA may be excluded, so that the response time of the system 100 may be further reduced.

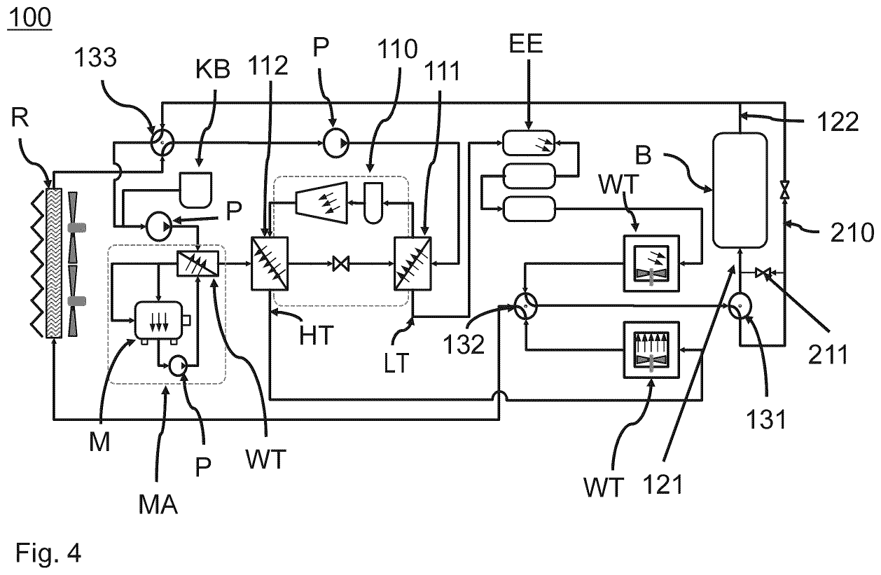

FIG. 4 shows third example aspects of a thermal energy system 100 which additionally includes a first bypass line 211. The battery bypass 210 and the first bypass line 211 each have, according to FIG. 4, an orifice. The first bypass line 211 conducts coolant from the battery bypass 210 to the battery access line 121. The first bypass line 211 begins upstream of the orifice of the battery bypass 210. By the first bypass line 211, when the coolant is conducted to the battery bypass 210, a bypass flow of coolant to the battery B may be adjustable, such that a low through-flow may be made possible. This may be adjustable, in particular, in such a way that a formation of a hot spot at and/or in the battery B may be suppressed, since sufficient cooling may be achieved by the low through-flow. In FIG. 4, the radiator R is in the closed state, such that an exchange of energy with the ambient air is suppressed.

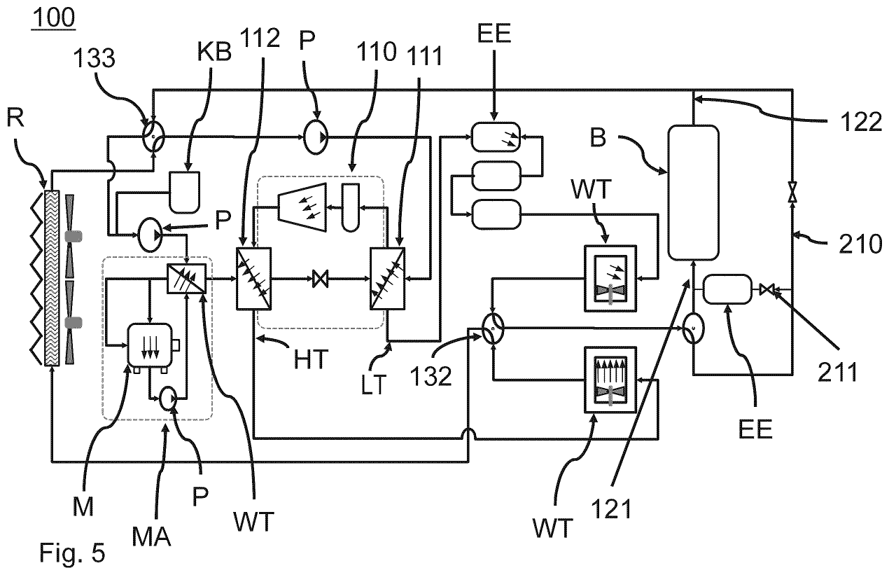

FIG. 5 shows fourth example aspects of a system 100 in which, in addition to FIG. 4, at least one electronics unit EE is integrated in the first bypass line 211 and downstream of the orifice in the first bypass line 211 in order to cool and/or heat, in particular to cool, the same. Therefore, a serial flow through the electronics unit EE in the first bypass line 211 and the battery B is possible. Accordingly, the formation of hot spots of the battery B and an introduction of thermal energy by this electronics unit EE and the battery B may also be controllable here by controlling the orifices in the first bypass line 211 and in the battery bypass 210. Advantageously, this electronics unit EE may be arranged upstream of the battery B, since this may have a lower heat capacity.

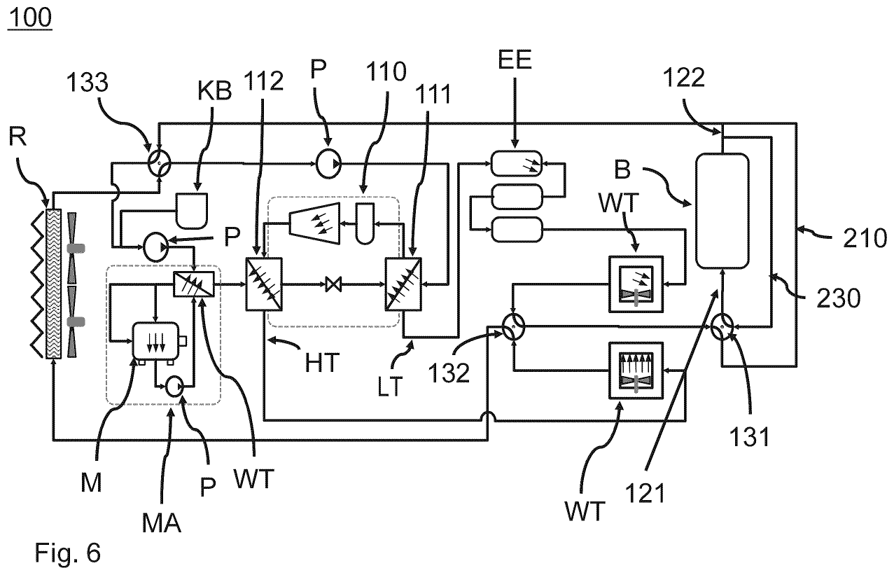

FIG. 6 shows fifth example aspects of a system 100 having a looped circuit 230 and the battery bypass 210. The looped circuit 230 may be a line. The looped circuit 230 may at least partially conduct the coolant from the battery outline line 122 to the first valve 131. The first valve 131 is in the second switching state and connects the looped circuit 230 to the battery access line 121. According to this design, the coolant may be conducted via the battery bypass 210 past the battery section BA. Coolant that is located in the battery section BA may contribute to the cooling of the battery B and thus heat up. If the coolant is conducted via the battery bypass 210, a passive cooling of the battery B via the housing thereof may be made possible. Due to local temperature differences, a flow of the coolant and thus a homogenization of the temperature distribution in the battery B is possible. The battery B may be selected in such a way that the convection is assisted. The battery B is advantageously arranged in such a way that the differences in density between coolant with different temperature levels avoid a local overheating in that the warmer coolant rises and the colder coolant flows in thereafter. Accordingly, the formation of hot spots and an introduction of energy into the main circuit may be kept low, such that the response time of the system 100 is further improved.

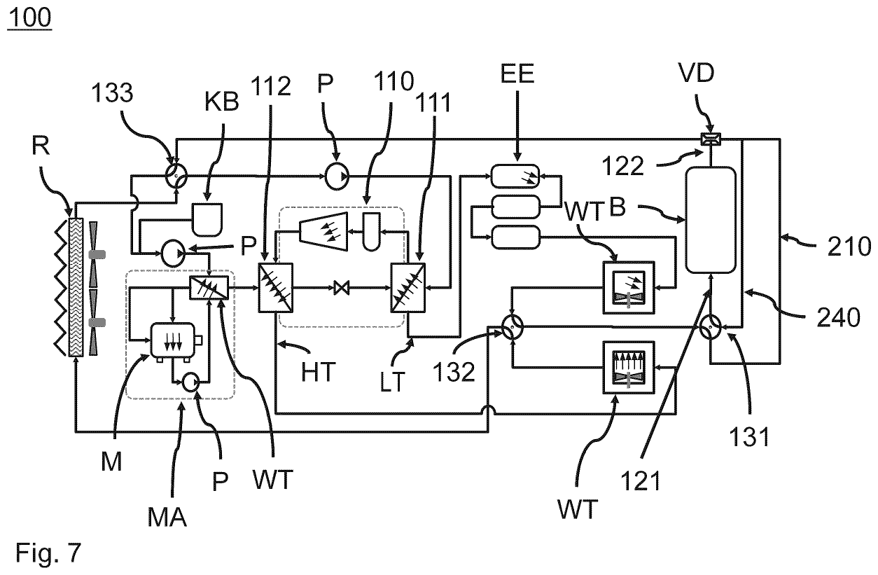

FIG. 7 shows sixth example aspects of a system 100 having the battery bypass 210, a Venturi nozzle VD, and a cooling line 240. The Venturi nozzle VD forms the beginning section of the single line. The battery bypass 210 is fluidically connected to the Venturi nozzle VD and the battery outlet line 122 is also fluidically connected to the Venturi nozzle VD. The cooling line 240 at least partially conducts the coolant from the battery bypass 210 to the first valve 131, in particular when the first valve 131 is in the second switching state, to the battery access line 121. The Venturi nozzle VD may be, alternatively, a suction jet pump. By the Venturi nozzle, a bypass flow of the coolant may be branched off from the main circuit and returned to the same. The pressure conditions upstream of and downstream of the Venturi nozzle make it possible to split a main flow of the coolant without an active pump and to combine same after the flow through the battery B.

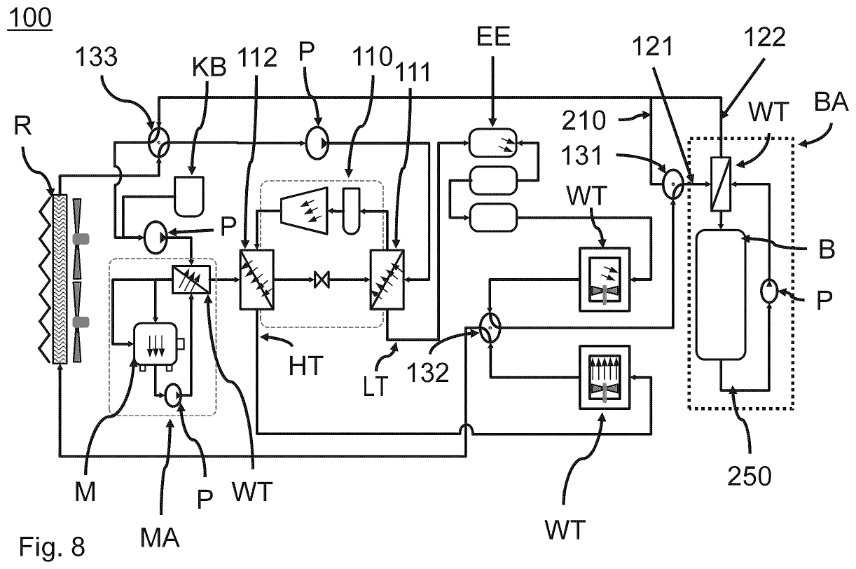

FIG. 8 shows seventh example aspects of a system 100 having the battery bypass 210 and an independent battery circuit 250. For this purpose, the system 100 also includes a heat exchanger WT of the battery section BA, wherein the coolant inlet of the battery section BA is, in this case, a coolant inlet and the coolant outlet of the battery section BA is a coolant outlet of the heat exchanger WT of the independent battery circuit 250. The battery circuit 250 is conducts a second coolant from the heat exchanger WT to the battery B and downstream of the battery B to the heat exchanger WT. The heat exchanger WT exchanges thermal energy between the coolant of the main circuit and of the battery circuit 250. The battery circuit 250 may include one or more lines. In addition, the battery circuit 250 according to FIG. 8 includes a pump downstream of the battery B and upstream of the heat exchanger WT. The second coolant of the battery circuit 250 may be identical to or different from the coolant of the main circuit. Therefore, the invention relates to a cooling circuit which is independent of the main circuit, the coolant of which cooling circuit physically has a greater change in density with respect to temperature and thus may achieve cooling that is optimized for the battery B. A connection to the main circuit is advantageous by the heat exchanger WT.

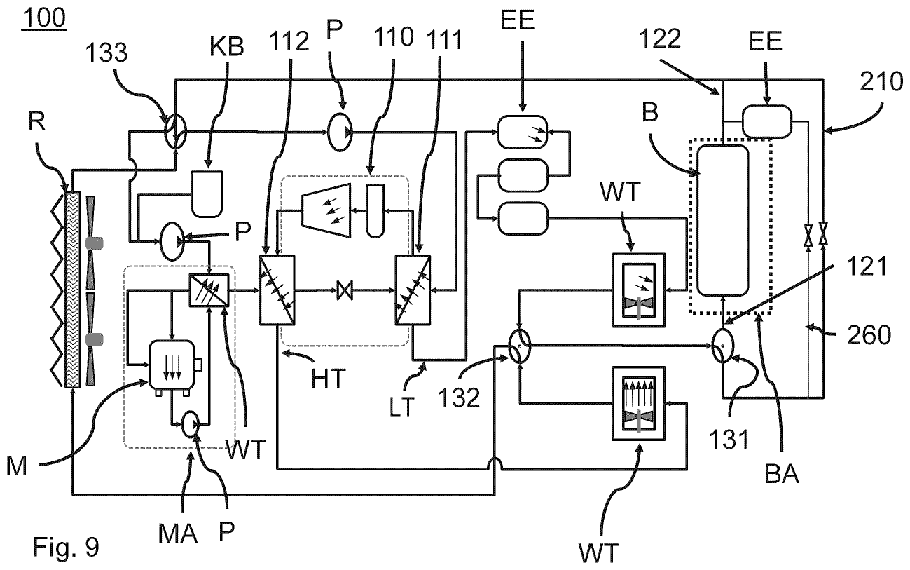

FIG. 9 shows eighth example aspects of a system 100 having the battery bypass 210 and an electronics bypass 260. The battery bypass 210 and the electronics bypass 260 each have a restrictor. The electronics bypass 260 at least partially conducts the coolant from the battery bypass 210 to the battery outlet line 122. The electronics bypass 260 also cools and/or heats an electronics unit EE along the electronics bypass 260. Therefore, a cooling and/or heating of the electronics unit EE along the electronics bypass 260 may be carried out parallel to the battery section BA, in particular the battery B, according to demand. An energy input of the battery B is also correspondingly low.

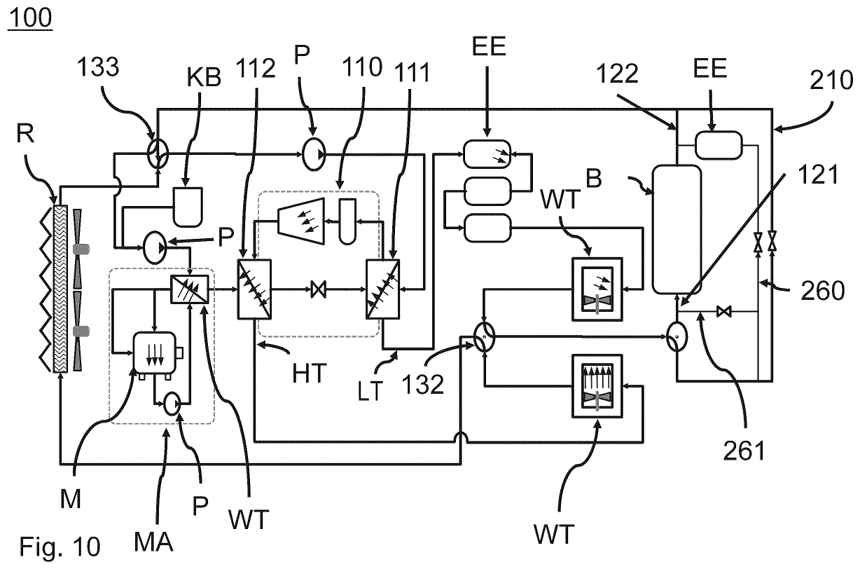

FIG. 10 shows ninth example aspects of a system 100 having the battery bypass 210, the electronics bypass 260, and a second bypass line 261. The battery bypass 210, the electronics bypass 260, and the second bypass line 261 each have a restrictor. The second bypass line 261 begins upstream of the restrictor in the electronics bypass 260 and at least partially conducts the coolant to the battery access line 121. Via the second bypass line 261, an additional branch of the coolant is provided, which is connected to the battery access line 121, wherein the restrictor limits the branching-off volumetric flow in such a way that hot spots are avoided, but a substantial introduction of energy into the main circuit does not take place.

The exemplary aspects of the system 100 shown in FIGS. 1 through 10 may be at least partially combined with one another and the invention is not limited to individual exemplary embodiments.

FIG. 11 shows a vehicle 300 having the system 100 according to one of FIGS. 1 through 10. The vehicle 300 may be an at least partially electrically propelled vehicle 300. The vehicle 300 may include one or more units and/or sections of the exemplary system 100 shown in FIGS. 1 through 10.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

100 thermal energy system
110 heat pump
111 cooling unit
112 heating unit
HT high-temperature line path
LT low-temperature line path
121 battery access line
122 battery outlet line
131 first valve
132 second valve
133 third valve
134 fourth valve
BA battery section
B battery
KA cooling section
WT heat exchanger
HA heating section
RA radiator section
R radiator
MA motor section
M motor
P pump
KB coolant container
EE electronics unit
VD Venturi nozzle
210 battery bypass
211 first bypass line
220 radiator bypass
230 looped circuit
240 cooling line
250 independent battery circuit
260 electronics bypass
261 second bypass line
300 vehicle

1-16: (canceled)

17. A thermal energy system (100) for controlling a temperature of a battery section (BA) having a battery (B) of a vehicle (300), comprising:
a heat pump (110) with a cooling unit (111) for cooling a coolant and a heating unit (112) for heating the coolant;
a low-temperature (LT) line path beginning downstream of the cooling unit (111) for conducting the coolant;
a high-temperature (HT) line path beginning downstream of the heating unit (112) for conducting the coolant;
a battery access line (121) fluidically connected to a coolant inlet of the battery section (BA);
a battery bypass (210) for conducting the coolant of one of the HT line path or the LT line path at least partially parallel to the battery section (BA); and
a first valve (131), the first valve (131) fluidically connecting the one of the HT line path or the LT line path to the battery access line (121) when the first valve (131) is in a first switching state, the first valve (131) fluidically connecting the one of the HT line path or the LT line path to the battery bypass (210) when the first valve (131) is in a second switching state.

18. The system (100) of claim 17, wherein the one of the HT line path or the LT line path is the LT line path.

19. The system (100) of claim 17, further comprising a battery outlet line (122) fluidically connected to a coolant outlet of the battery section (BA),
wherein the battery outlet line (122) and the battery bypass (210) are merged downstream of the battery section (BA) to form a single line.

20. The system (100) of claim 17, wherein the battery bypass (210) has a first bypass line (211), the first bypass line (211) at least partially conducts the coolant from the battery bypass (210) to the battery access line (121).

21. The system (100) of claim 20, wherein the first bypass line (211) at least one of cools or heats a first electronics unit (EE) of the vehicle (300).

22. The system (100) of claim 21, wherein one or both of:
the first bypass line (211) has at least one of an orifice or a restrictor upstream of the first electronics unit (EE); or
the battery bypass (210) has at least one of an orifice or a restrictor downstream of the first bypass line (211).

23. The system (100) of claim 17, further comprising a looped circuit (230), the looped circuit (230) at least partially conducting the coolant from a battery outlet line (122) to the first valve (131) and via the first valve (131) to the battery access line (121) when the first valve (131) is in the second switching state.

24. The system (100) of claim 23, wherein at least one of a convective circulation or a gravity-driven circulation of a coolant in the looped circuit (230) and the battery (B) is implementable via the looped circuit (230).

25. The system (100) of claim 17, further comprising:
a Venturi nozzle (VD) fluidically connected to the battery section (BA), the Venturi nozzle (VD) being fluidically connected to the battery (B) by a battery outlet line (122) and to the first valve (131) by the battery bypass (210); and
a cooling line (240), the cooling line (240) at least partially conducting the coolant from the battery bypass (210) to the first valve (131) and via the first valve (131) to the battery access line (121) when the first valve (131) is in the second switching state,
wherein the coolant is at least partially suctionable from the battery outlet line (122) by the Venturi nozzle (VD).

26. The system (100) of claim 17, further comprising:
a heat exchanger (WT) of the battery section (BA), a coolant inlet of the heat exchanger (WT) of the battery section (BA) forming the coolant inlet of the battery section (BA) and a coolant outlet of the heat exchanger (WT) of the battery section (BA) forming the coolant outlet of the battery section (BA); and
an independent battery circuit (250), the independent battery circuit (250) at least one of cools or heats the battery (B) by a second coolant,
wherein the heat exchanger (WT) of the battery section (BA) exchanges thermal energy between the independent battery circuit (250) and the coolant flowing from the battery access line (121) to a battery outlet line (122).

27. The system (100) of claim 17, further comprising an electronics bypass (260), the electronics bypass (260) at least partially conducting the coolant from the battery bypass (210) to a battery outlet line (122) and to at least one of cool or heat a second electronics unit (EE) of the vehicle (300).

28. The system (100) of claim 27, further comprising a second bypass line (261), the second bypass line (261) beginning upstream of the second electronics unit (EE) and at least partially conducting the coolant from the electronics bypass (260) to the battery access line (121).

29. The system (100) of claim 17, wherein the thermal energy system (100) at least one of cools or heats, by the HT line path and the LT line path, one or more of:
a cooling section (KA) having one or both of a third electronics unit (EE) of the vehicle (300) or a passenger compartment heat exchanger (WT) for cooling a passenger compartment of the vehicle (300);
a motor section (MA) having a motor (M) of the vehicle (300), the thermal energy system (100) conducting the coolant from the motor section (MA) to the heating unit (112);
a heating section (HA) having another passenger compartment heat exchanger (WT) for heating the passenger compartment; or
a radiator section (RA) having a radiator (R) of the vehicle (300).

30. The system (100) of claim 29, further comprising one or both of:
a second valve (132), the second valve (132) fluidically connecting the cooling section (KA) to the radiator section (RA) and fluidically connecting the heating section (HA) to the first valve (131) when in a first switching state, the second valve (132) fluidically connecting the cooling section (KA) to the first valve (131) and fluidically connecting the heating section (HA) to the radiator section (RA) when in a second switching state; or
a third valve (133), the third valve (133) fluidically connecting a single line to the motor section (MA) and fluidically connecting the radiator section (RA) to the cooling unit (111) when in a first switching state, the third valve (133) fluidically connecting the single line to the cooling unit (111) and fluidically connecting the radiator section (RA) to the motor section (MA) when in a second switching state, the single line being formed by a battery outlet line (122) and the battery bypass (210) being merged downstream of the battery section (BA).

31. The system (100) of claim 29, wherein an exchange of thermal energy between an ambient fluid of surroundings and the coolant of the radiator section (RA) is providable when the radiator (R) is in an open state, and
wherein the exchange of thermal energy with the ambient fluid is at least partially suppressible when the radiator (R) is in a closed state.

32. The system (100) of claim 29, further comprising:
a radiator bypass (220), the coolant being conductible parallel to the radiator section (RA) via the radiator bypass (220); and
a fourth valve (134), the coolant being conductible to the radiator bypass (220) when the fourth valve (134) is in a first switching state, the coolant being conductible to the radiator section (RA) when the fourth valve (134) is in a second switching state.

33. A vehicle (300), comprising the thermal energy system (100) of claim 17.
